(19) United States
(12) Patent Application Publication
(10) Pub. No.: US 2012/0191910 A1
(43) Pub. Date: Jul. 26, 2012

(54) PROCESSING CIRCUIT AND METHOD FOR READING DATA

(76) Inventors: Yen-Ju Lu, Hsinchu City (TW); Chao-Wei Huang, New Taipei City (TW)

(21) Appl. No.: 13/345,754

(22) Filed: Jan. 9, 2012

(30) Foreign Application Priority Data
Jan. 20, 2011 (CN) 201110023398.7

(51) Int. Cl. G06F 12/00; G06F 12/08

(52) U.S. Cl. 711/118; 711/154; 711/E12.001; 711/E12.017

(57) ABSTRACT

A processing circuit includes a processing unit and a data buffer. When the processing unit receives a load instruction and determines that the load instruction has a load-use condition, the processing unit stores specific data into the data buffer, where the specific data is loaded by executing the load instruction.

### BACKGROUND OF THE INVENTION

1. Field of the Invention

The present invention relates to a processing circuit and a method for reading data.

2. Description of the Prior Art

When a processor needs to execute a current instruction by using data loaded by a previous instruction, a load-use penalty issue may be happened, that is the execution of the current instruction may be deferred due to the wait of the data loaded by the previous instruction. For example, please refer to FIG. 1, assuming that the processor receives a load instruction and an add instruction, where the load instruction is to ask the processor to load required data from an external memory or a cache memory, and the add instruction is to ask the processor to add the loaded data. Taking a 5-stage pipeline as an example, the processor executes the load instruction by performing “instruction fetch”, “decode”, “execute”, “memory access” and “write back” operations at times t1-t5, respectively, and the processor starts to execute the add instruction at time t2. However, because the processor needs to use the loaded data of the load instruction to execute the add instruction, the processor cannot perform the “execute” operation of the add instruction until the required data is loaded (i.e., at time t5). Therefore, when the processor executes the add instruction, a bubble (suspend) occurs at time t4, that is there is a load-use penalty at time t4, and the performance of the processor is degraded.

In addition, in a higher frequency processor implementing more pipeline stages (e.g., 8-stage pipeline), load-use penalty will happen more frequently, induce more pipeline bubbles, and furthermore the performance of the processor is seriously degraded.

### SUMMARY OF THE INVENTION

One object of the present invention is to provide a processing circuit and a method for reading data, which can effectively reduce the load-use penalties, to improve the efficiency of the processor.

According to one embodiment of the present invention, a processing circuit includes a processing unit and a data buffer. When the processing unit receives a load instruction and determines that the load instruction has a load-use condition, the processing unit stores specific data into the data buffer, where the specific data is loaded by executing the load instruction.

According to another embodiment of the present invention, a method for reading data includes: providing a data buffer; receiving a load instruction and determining whether the load instruction has a load-use condition; and when the load instruction is determined to have a load-use condition, storing specific data into the data buffer, where the specific data is loaded by executing the load instruction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a load-use event.

FIG. 2 is a diagram illustrating a processing circuit according to one embodiment of the present invention.

FIG. 3 is a flowchart of a method for reading data according to one embodiment of the present invention.

FIG. 4 is a diagram illustrating the processing unit using a 5-stage pipeline to execute a load instruction and an add instruction.

### DETAILED DESCRIPTION

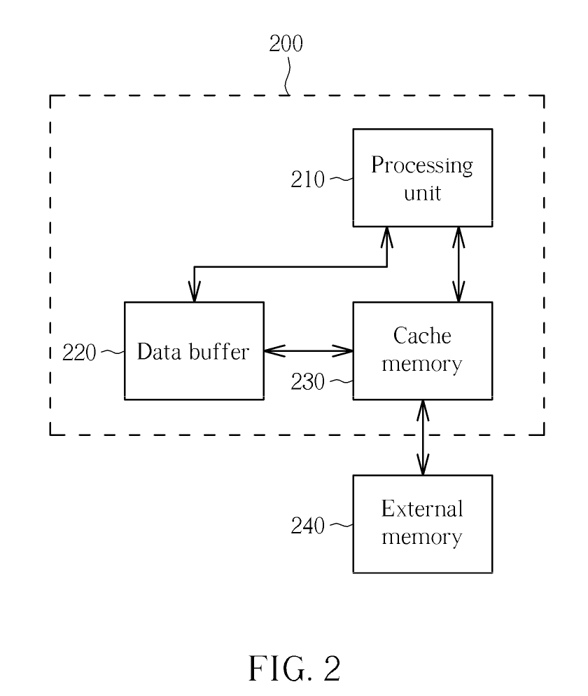

Please refer to FIG. 2, which is a diagram illustrating a processing circuit 200 according to one embodiment of the present invention. As shown in FIG. 2, the processing circuit 200 includes a processing unit 210, a data buffer 220, and a cache memory 230, where the data buffer 220 is implemented by a plurality of registers, and the cache memory 230 is implemented by a static random access memory (SRAM). Furthermore, for the processing unit 210, the access speed of the data buffer 220 is faster than the access speed of the cache memory 230.

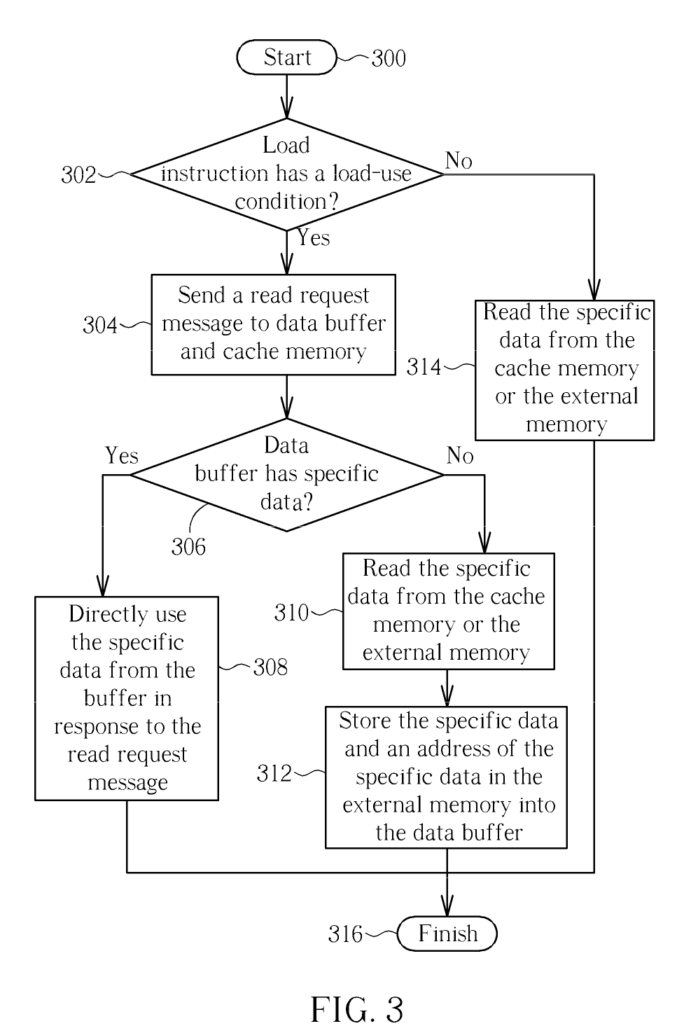

Please refer to FIG. 2 and FIG. 3 together. FIG. 3 is a flowchart of a method for reading data according to one embodiment of the present invention. Referring to FIG. 3, the flow is described as follows.

In Step 300, the flow starts. In Step 302, the processing unit 210 receives a load instruction, where the load instruction is to ask the processing unit 210 to load specific data from the external memory 240 or the cache memory 230. Then, the processing unit 210 determines whether the load instruction has a load-use condition, that is, it is determined that whether the processing unit 210 needs to execute a use instruction which uses the specific data immediately after the load instruction. If the load instruction has the load-use condition, the flow enters Step 304; and if the load instruction does not have the load-use condition, the flow enters Step 314 to read data from the cache memory 230 or the external memory 240 directly.

In Step 304, the processing unit 210 sends a read request to the data buffer 220 and the cache memory 230 simultaneously, to ask to read/load the specific data. Then, in Step 306, the data buffer 220 determines whether the specific data is stored herein. If the data buffer 220 has the specific data, the flow enters Step 308 and the processing unit 210 directly uses the specific data from the data buffer 220 in response to the read request, and the processing unit 210 does not use the data received from the cache memory 230. If the data buffer 220 does not have the specific data, the flow enters Step 310 and the processing unit reads the specific data from the cache memory 230 or the external memory 240 directly.

Then, in Step 312, the processing unit 210 stores the specific data and an address of the specific data in the external memory 240 into the data buffer 220. Particularly, considering a capacity of the data buffer 220, the processing unit 210 uses a least recently used (LRU) algorithm to store the specific data and the address of the specific data in the external memory 240 into the data buffer 220, that is when the data buffer 220 is filled, the data buffer 220 discards the least recently used data. Finally, the flow enters Step 316 to finish the operations of the load instruction executed by the processing unit 210.

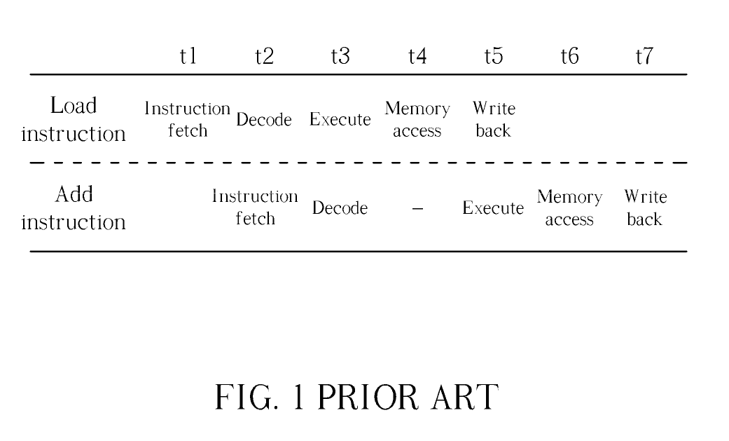

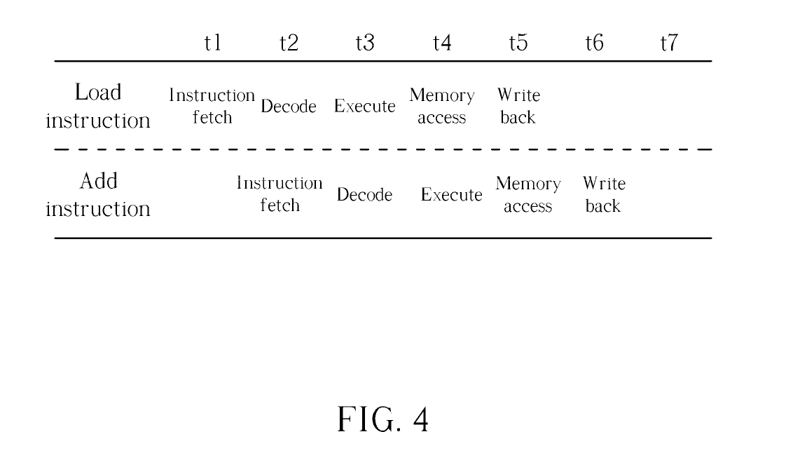

In light of above, when the processing unit 210 determines that the load instruction has a load-use condition (i.e., a load-use penalty will be happened when the next instruction is executed), the processing unit 210 stores the loaded data and its address in the external memory 240 into the data buffer 220. Therefore, next time when the processing unit 210 needs to read/load the specific data once again, the processing unit 210 can directly read the specific data from the data buffer 220. Because the access speed of the data buffer 220 is very fast, the processing unit 210 can immediately obtain the specific data, and the bubble (suspend) may not occur when the processing unit 210 executes the use instruction. That is, the load-use penalty can be prevented. For example, please refer to FIG. 4, assuming that the processing unit 210 receives a load instruction and an add instruction, where the load instruction is to ask the processing unit 210 to load required data from the external memory 240 or the cache memory 230, and the add instruction is to ask the processing unit 210 to add the loaded data. Taking a 5-stage pipeline as an example, the processing unit 210 executes the load instruction by performing “instruction fetch”, “decode”, “execute”, “memory access” and “write back” operations at times t1-t5, respectively, and the processing unit 210 starts to execute the add instruction at time t2. Because the processing unit 210 can immediately obtain the required data from the data buffer 220 at the time t4, the “execute” operation of the add instruction can also be performed at the time t4 without being delayed as shown in FIG. 1.

In addition, because the data buffer 220 stores the data loaded data and its address in the external memory 240, the read request sent from the processing unit 210 (in Step 304) includes an external memory address. In Step 306, the data buffer 220 can determines whether the data buffer 220 has the specific data by determining whether the data buffer 220 has the same external memory address.

In the Step 312 described above, the data buffer 220 uses the LRU algorithm to store the specific data and the address of the specific data in the external memory 240 into the data buffer 220, that is when the data buffer 220 is filled, the data buffer 220 discards the least recently used data. However, in another embodiment of the present invention, the data buffer stores the data and its corresponding counting value that represents the used times of the data; and when the data buffer 220 is filled, the data buffer 220 discards the data according to its counting value (i.e., discard the data whose counting value (used times) is the smallest).

In addition, when the data stored in the external memory 230 is refreshed/overwritten, the corresponding data stored in the data buffer 220 may become incorrect. Therefore, in this embodiment, when the specific data stored in the external memory 230 is refreshed/overwritten, the processing unit 210 will refresh the specific data stored in the data buffer 220 simultaneously, or the processing unit 210 will delete the specific data stored in the data buffer 220 to prevent from reading the error data.

Briefly summarized, in the processing circuit and the method for reading data of the present invention, when the processing unit determines that the load instruction has a load-use condition, the processing unit stores the loaded data and the address of the loaded data in the external memory into the data buffer. Therefore, next time when the processing unit needs to read/load the specific data once again, the processing unit can directly read the specific data from the data buffer to prevent a load-use penalty when a next instruction needs to use this specific data. Therefore, the performance of the processing circuit can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processing circuit, comprising:
a processing unit, for receiving a load instruction; and
a data buffer, coupled to the processing unit;
wherein when the processing unit receives the load instruction and determines that the load instruction has a load-use condition, the processing unit stores specific data into the data buffer, where the specific data is loaded by executing the load instruction.

2. The processing circuit of claim 1, wherein the load-use condition means that a load-use penalty will happen when the processing unit executes a next instruction immediately following the load instruction.

3. The processing circuit of claim 1, wherein the processing unit stores the specific data and an address of the specific data in an external memory into the data buffer.

4. The processing circuit of claim 1, further comprising:
a cache memory, coupled between the processing unit and an external memory, wherein the external memory stores the specific data;
wherein when the processing unit intends to read the specific data from the external memory, the processing unit sends a read request to the data buffer and the cache memory simultaneously.

5. The processing circuit of claim 4, wherein when the data buffer has the specific data data, the processing unit directly uses the required data received from the data buffer in response to the read request, and does not use the data received from the cache memory.

6. The processing circuit of claim 4, wherein when the processing unit determines that the load instruction does not have the load-use penalty, the processing unit directly reads the specific data from the cache memory or the external memory.

7. The processing circuit of claim 4, wherein the data buffer includes a plurality of registers, and the cache memory is a static random access memory.

8. The processing circuit of claim 1, wherein the processing unit utilizes a least recently used algorithm to store the specific data and an address of the specific data in an external memory into the data buffer.

9. The processing circuit of claim 1, wherein when the data buffer is filled, the processing unit discards data whose used times is the smallest from the data buffer.

10. A method for reading data, comprising:
receiving a load instruction;
determining whether the load instruction has a load-use condition; and
when the load instruction is determined to have the load-use condition, storing specific data into the data buffer, where the specific data is loaded by executing the load instruction.

11. The method of claim 10, wherein the load-use condition means that a load-use penalty will happen when a next instruction is executed immediately following the load instruction.

12. The method of claim 10, wherein the step of storing specific data into the data buffer comprises:
storing the specific data and an address of the specific data in an external memory into the data buffer.

13. The method of claim 10, further comprising:
providing a cache memory coupled between the processing unit and an external memory, wherein the external memory stores the specific data;
wherein when it is intended to read the specific data from the external memory, sending a read request to the data buffer and the cache memory simultaneously.

14. The method of claim 13, wherein when the data buffer has the specific data, the processing unit directly uses the specific data received from the data buffer in response to the read request, and does not use the data received from the cache memory.

15. The method of claim 13, further comprising:
when it is determined that the load instruction does not have the load-use penalty, directly reading the specific data from the cache memory or the external memory.

16. The method of claim 10, further comprising:
utilizing a least recently used algorithm to store the specific data and an address of the specific data in an external memory into the data buffer.

17. The method of claim 10, further comprising:
when the data buffer is filled, the processing unit discards data whose used times is the smallest from the data buffer.
